(19) United States
(12) Patent Application Publication
(10) Pub. No.: US 2012/0295233 A1
(43) Pub. Date: Nov. 22, 2012

(54) COMPUTERIZED SYSTEM AND METHOD FOR MONITORING FOOD CONSUMPTION

(75) Inventor: Alin COOPERMAN, Tel Aviv (IL)

(73) Assignee: MAKEMYPLATE LTD., Tel Aviv (IL)

(21) Appl. No.: 13/474,395

(22) Filed: May 17, 2012

Related U.S. Application Data
(60) Provisional application No. 61/487,420, filed on May 18, 2011.

(51) Int. Cl. G09B 19/00

(52) U.S. Cl. 434/127

(57) ABSTRACT

A computerized method and system for monitoring food consumption.

### FIELD OF THE INVENTION

This invention relates to a computerized method for monitoring food consumption of an individual.

### BACKGROUND OF THE INVENTION

During the past decade, rapid expansion in a number of relevant scientific fields and, in particular, in the amount of population-based epidemiological evidence has helped to clarify the role of nutrition and diet in preventing and controlling morbidity and premature mortality resulting from conditions and diseases, which may at time be chronic conditions, such as obesity, diabetes, cardiovascular disease (CVD), hypertension, stroke, and some types of cancer. Some of the specific dietary components that increase the probability of occurrence of these diseases in individuals, and interventions to modify their impact, have also been identified.

Furthermore, rapid changes in diets and lifestyles that have occurred with industrialization, urbanization, economic development and market globalization, have accelerated over the past decade. This is having a significant impact on the health and nutritional status of populations (in every age, sex or economical status groups). While standards of living have improved, food availability has expanded and become more diversified, and its accessibility has increased, there have also been significant negative consequences in terms of inappropriate dietary patterns, decreased physical activities and increased tobacco use, and a corresponding increase in diet-related chronic diseases, especially among young individuals.

Food and food products have become commodities produced and traded in a market that has expanded from an essentially local base to an increasingly global one. Changes in the world food economy are reflected in shifting dietary patterns, for example, increased consumption of energy-dense diets high in fat, particularly saturated fat, and low in unrefined carbohydrates. These patterns are combined with a decline in energy expenditure that is associated with a sedentary lifestyle—motorized transport, labour-saving devices in the home, the phasing out of physically demanding manual tasks in the workplace, and leisure time that is preponderantly devoted to physically undemanding pastimes.

Because of these changes in dietary and lifestyle patterns, chronic conditions and diseases including obesity, diabetes, CVD, hypertension and stroke, and cancer are becoming increasingly significant causes of disability and premature death in both developing and newly developed countries, placing additional burdens on national health budgets.

It is therefore a need for individual applicable tools permitting the monitoring of food consumption thereby allowing the continuous observation of the nutritional value of consumed food in order for said individual

### SUMMARY OF THE INVENTION

The invention provides a computerized method for monitoring food consumption of an individual.

In one aspect the invention provides a method comprising:
displaying on a computer screen one or more food holding utensils resembling a utensil used by an individual in real life;
providing means for inputting information on food items consumed by individual; and
displaying an image resembling such food items on said utensil.
   thereby monitoring the food consumption of an individual.

In one embodiment, said utensil is a plate, bowl, box, cup, glass or hand-full.

In a further embodiment, said input means are provided within the form of a visualized catalogue of food items.

In yet a further embodiment, said visualized catalogue provides the nutritional value of food items. In another embodiment, said visualized catalogue includes virtual representation of food items resembling food items consumed by the individual in real life.

In another embodiment of the invention, said displaying of an image resembling such food items on said utensil includes nutritional data of said food items.

In a further embodiment, said information inputted on food items over a time period consumed by the individual is accumulated.

In yet a further embodiment, a method of the invention comprises defining a time period and displaying information on food items consumed over said time period.

In another embodiment, a predetermined measure amount and type of food items are defined, providing an individual means for inputting information on food items consumed from predetermined measures.

In another embodiment of a method of the invention is operable over a computer network. In a specific embodiment, a method of the invention is operable in a server-client system, said server comprising a data storage and a software for executing the method. In a further specific embodiment, the computer network is the internet.

In a further aspect, the invention provides a client server system comprising a plurality of clients and one or more serves, the clients and the one or more servers being connected through a computer network, the server containing an executable software and a database for execution of the method of the invention.

In yet a further aspect, the invention provides a data storage device storing a computer executable software for execution of the method of the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a screen display of a system of the invention demonstrating the food category display of a system of the invention.

FIG. 2 shows a screen display of a system of the invention demonstrating a selection of general items form display.

FIG. 3 shows a screen display of a system of the invention demonstrating a selection of a specific item from display.

FIG. 4 shows a screen display of a system of the invention demonstrating a plate with selected food indicating nutritional values of selected foods.

FIG. 5 shows a screen display of a system of the invention demonstrating a plate with selected food indicating nutritional values of selected foods and optional alternatives adjusted for personal profile of the user.

FIG. 6 shows a screen display of a system of the invention demonstrating a plate with selected food indicating nutritional values of selected foods and optional alternatives adjusted for a selected alternative (here less calories food options of selected foods).

FIG. 7 shows a screen display of a system of the invention demonstrating selected food ingredients for preparing a recipe indicating options adapted for individual predetermined needs.

FIG. 8 shows a screen display of a system of the invention demonstrating restaurant's menu options indicating nutritional values of selected foods.

FIG. 9 shows a screen display of a system of the invention implemented on a portable device.

### DETAILED DESCRIPTION OF EMBODIMENTS

As the percentage of the population in the US and Europe considered to be overweight or obese continues to increase at an alarming rate, many will seek help from commercial diet aids. The sharp rise in childhood obesity indicates that we can also expect considerable future growth in this sector of the market. In the US alone, 66% of the population is overweight. At any given time 75 million Americans are on a diet. 50 million will diet independently, and 10-25 million will pay for help to lose weight.

Most dieticians recommend keeping a diary which tracks, and helps control the amount of calories consumed per day. Calorie counters and formats for food diaries can be found online The food is generally presented in extensive alphabetized tables, and the food is quantified by weight, making it hard to visualize what a portion would look like. This system is not user friendly and is not compatible with real life dining. Overall the tracking becomes tedious, making dieting an unpleasant experience. For children and teenagers this process resembles homework, discouraging them from persisting.

The unique aspect of the method and system of the invention is the real-life visualization and thus, user friendly presentation of the food consumed by an individual in a pre-determined period of time. The information is presented in using realistic photos and representations. Moreover, this method affords an easier and more accessible tool, since the visual information is better and faster understood and processed than written information, especially for when considering young populations such as small children and teenagers.

The visual basis of the system will allow to develop unique features that will create the platform for enhancing the individual User Interface experience and also a social network to increase dieting success.

The system can also be a useful tool for diets beyond weight loss, gain or maintenance; as varied as diabetes control to athletic training.

Users of the system and methods of the invention may include individual users, physicians and/or dietitians which may either use the system for monitoring multiple users or also be able to prepare beforehand dietary plans for an individual under their care.

Each user starts with an empty plate. Instead of choosing from a long list of food choices, the products in our system will be arranged in photos according to their different categories. On the computer screen the desired foods can be dragged over to fill the plate, creating a visual picture of the meal.

In another embodiment of the invention each user starts with a predetermined plate comprising pre-defined food items selected by a care giver (doctor, dietician and so forth). After food is consumed, said individual or care giver, may be able to input the actual amount of food consumed by individual (of each food item in predetermined plate). Thus, providing a monitor of food consumed by individual.

This visual and dynamic system can make all the dieting experience more positive, fun and enjoyable, by creating an interactive system that resembles a game.

The Interactive Calorie Calculator

Once the user builds the plate including the nutritional facts, he or she can choose to share this plate with others, and start a network.

Once users create and share their plates, they will be able to:
Explore Other User's Plates: options will include searching for the most popular plates, or looking for specific parameters, for example, a 500 cal. meal with high protein content. Users will be able to tag their plates with a label such as weight loss, diabetic, osteoporosis, athletic training etc., thereby building a database of meals for different dietary needs. For example, a diabetic user trying to lose weight will be able to look for a 300 cal. diabetic dinner.
Rate Plates: users can give a score to the shared plates and add their comments, ask the creator questions (encouraging interaction and support) and offer suggestions and tips.
My Favorites: Every user will have a “My Favorites” category. The user can, for example, choose to add plates that they had created and were particularly satisfying; plates copied other users' profiles, add plates recommended by a specific dietician or save special dishes from a restaurant participating in the site.
Predetermined Plate: In some embodiments of a method and system of the invention a predetermined menu is defined for a certain individual by a care giver (such as for example a doctor or dietician at a health facility or at the home environment of said individual). In such instances the predetermined menu is selected in accordance with a physical or emotional condition, disorder or disease of said individual. Said individual or care-giver may then be able to input the exact amount consumed by individual of each food item in predetermined plate. Thus, a monitor on the consumption of food and nutritional balance of said individual is maintained.

Social Network:

The interactive nature of the site will encourage development of social networks. These networks will function as support groups. The element of peer support has been shown to be very important in dieting success. After creating their plates, the next step is for the users to share their creations. By tagging their plates and their personal accounts, users can communicate with other dieters by joining interest groups, sharing recipes, health tips, and their personal dieting story. The plates, continually being created and shared by the users, keep the beat pulsing within the network and encouraging the user to both stay with the diet and continue to use the site.

Simple Measuring Units:

For example, instead of measuring weighable amounts of food (wherein the user must use scales for measuring the exact food portion consumed), in the system of the invention (for example the online plate), not only will the user have easy measurement devices, e.g., spoons, cups, hand-full etc., but the user will be able to estimate how much he ate visually, by seeing a portion on the plate and enlarging or reducing the amount of food article consumed and the exact corresponding calories on the computer screen.

An Immediate Output:

This interactive system will provide the user an immediate output and an automatic nutritional count summary. The nutritional facts regarding the content of each plate can be arranged according to individual needs (carbohydrates before calories, for example). This way, the user can interactively and prior to consumption of the food item try and create new combinations based on nutrition needs, which can be defined in advance.

Restaurant Menus:

Restaurants will be able to upload photos of food from their menus along with nutritional facts; the user can simply choose the restaurant plate and update their food diary. This will allow the users to eat in restaurants, while still keeping track of their food intake.

Cellular, Pocket or Tablet PC, Hand-Held Devices:

A cellular or tablet application will let people to take their food diary anywhere, and encourage updating the program right after meals. In this way they can be notified in real time of preset limit alerts, for example if they reach their limit on calories or too little protein for the day. It can also help them decide whether they can afford to eat that second helping of pie, based on their record for that day.

Diabetics and Special Groups:

Unique features will be adapted for special needs. For example, diabetics will be able to evaluate the carbohydrate consumption of a meal in order to facilitate calculation of insulin need. Other applications can be developed for osteoporosis, celiac, athletes etc.

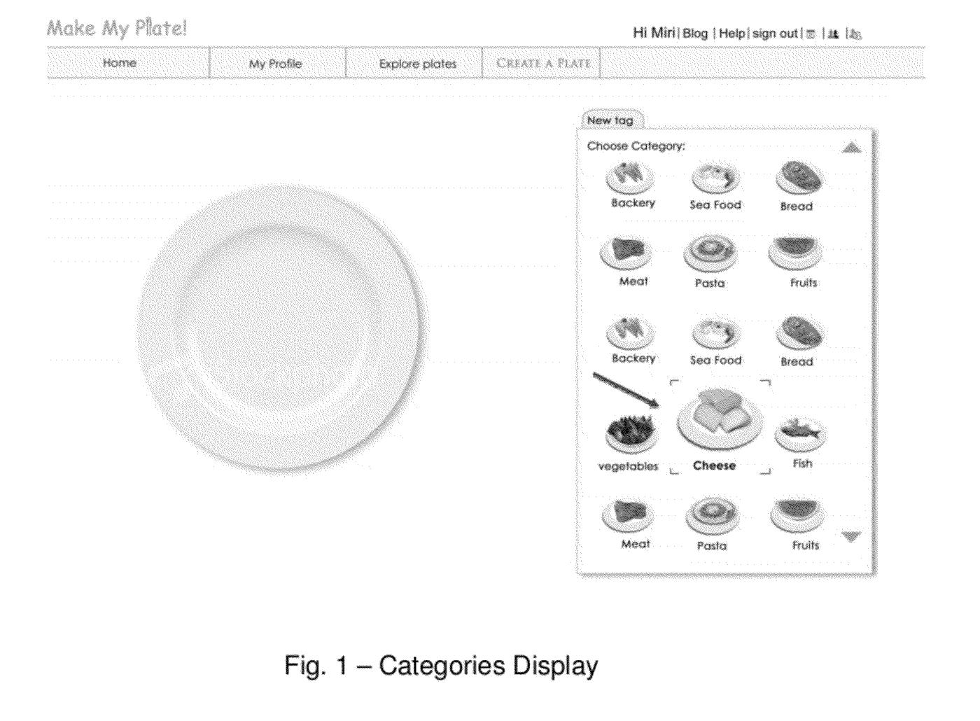

FIGS. 1-8 demonstrate one embodiment of a system and method of the invention.

FIG. 1 shows a screen display of a system of the invention demonstrating the food category display of a system of the invention. The food item options are displayed on the right. As can be seen the category “cheese” is selected. The figures also shows a plate wherein the food item will be displayed upon.

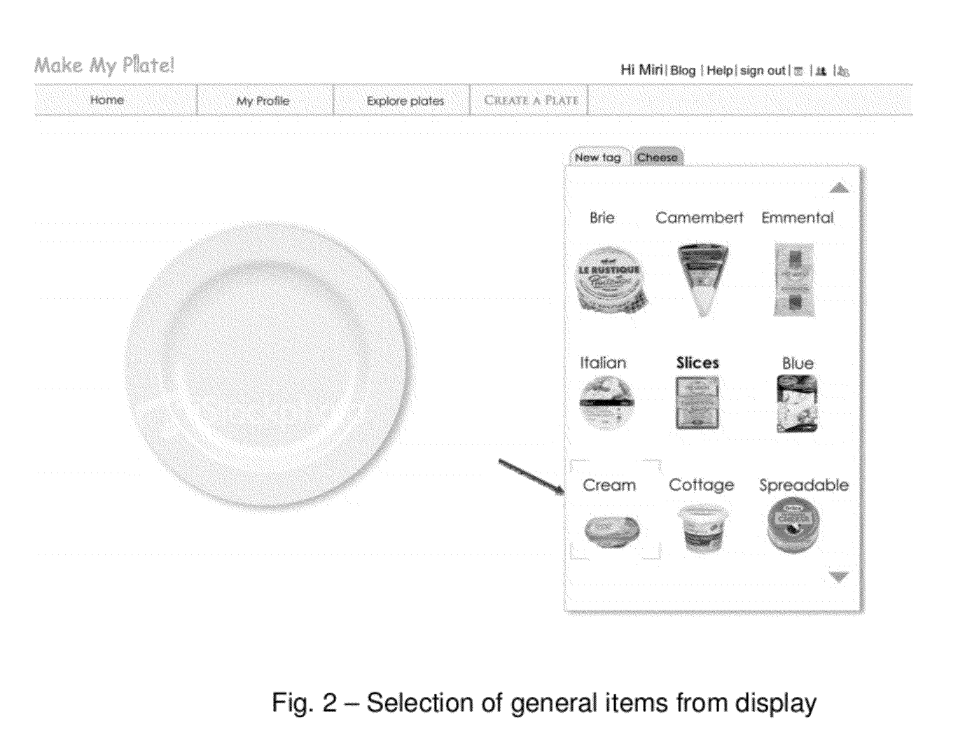

FIG. 2 shows a screen display of a system of the invention demonstrating a selection of general items form display. Here a user can specifically choose the type of food item to be displayed and consumed. Here the user chooses the type indicated as cream cheese.

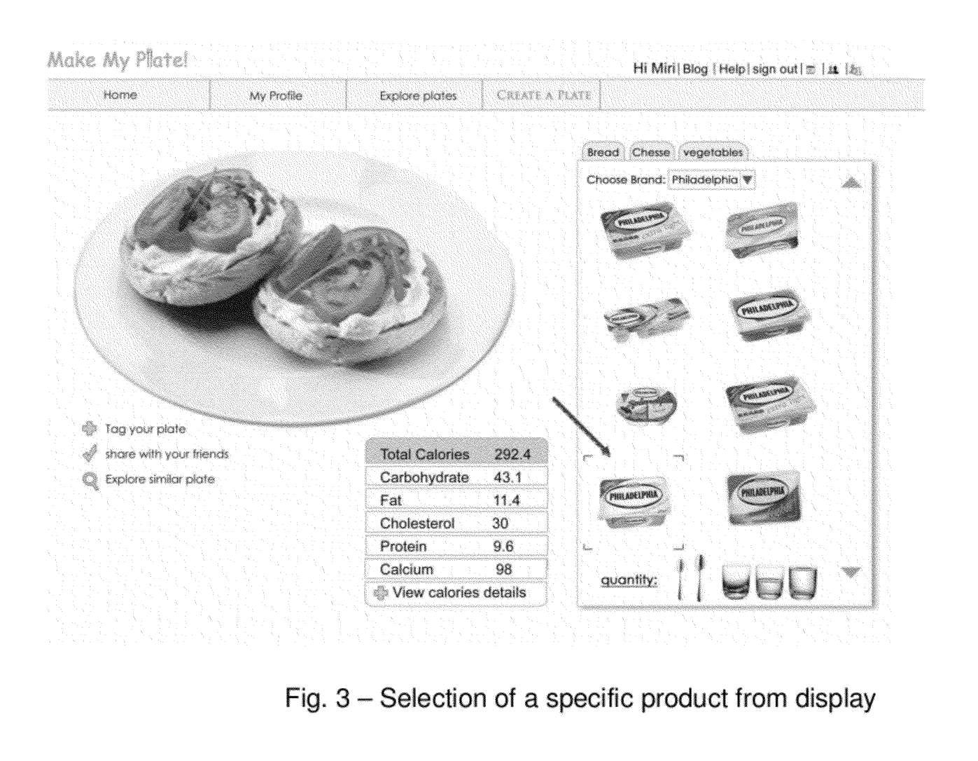

FIG. 3 shows a screen display of a system of the invention demonstrating a selection of a specific item from display. The figure shows a plate wherein the user choose the type of bread and cheese consumed. The system and method of the invention visualize the food item accurately on the plate and the user can relate to the amount of food consumed. The system also displays the nutritional values of the items chosen.

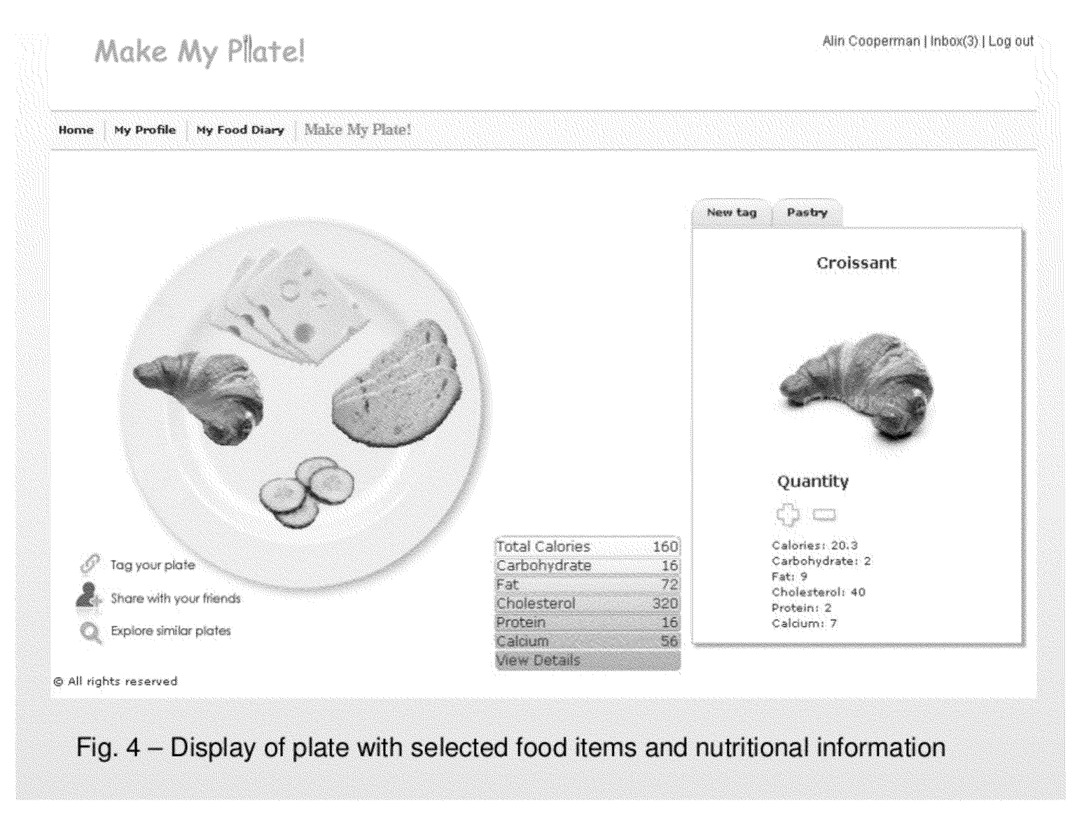

FIG. 4 shows a screen display of a system of the invention demonstrating a plate with selected food indicating nutritional values of selected foods.

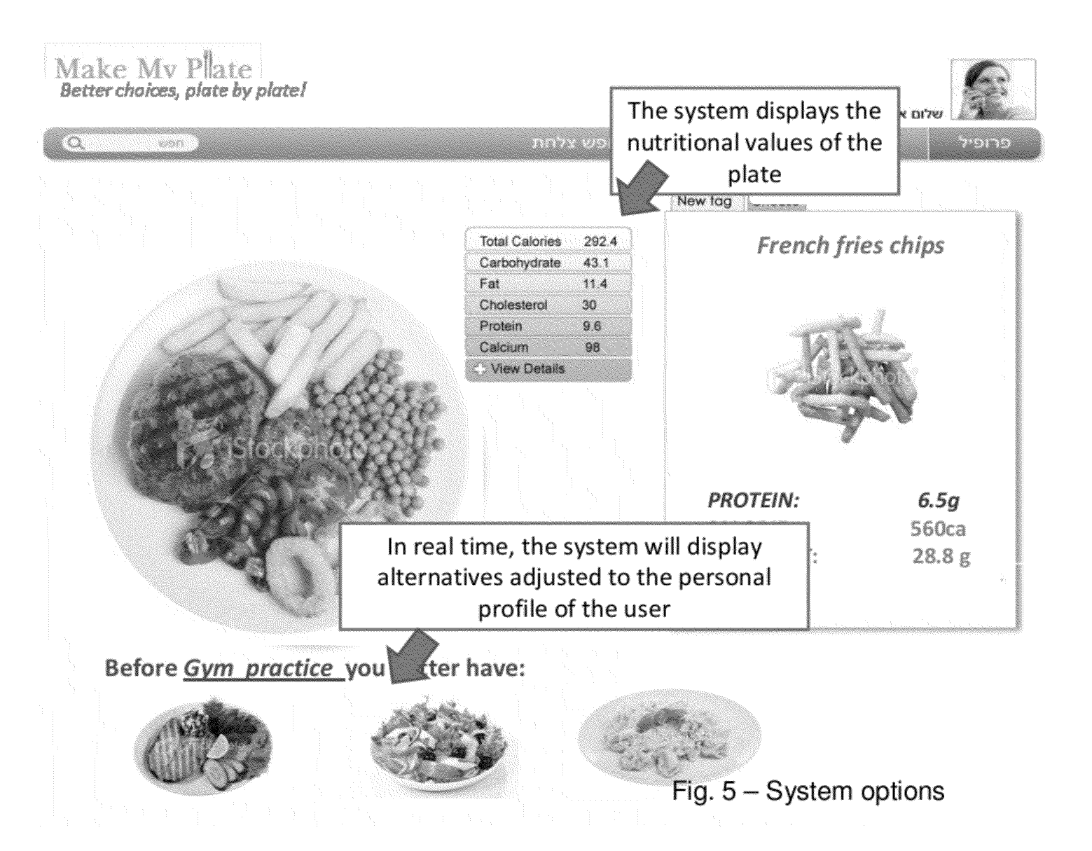

FIG. 5 shows a screen display of a system of the invention demonstrating a plate with selected food indicating nutritional values of selected foods and optional alternatives adjusted for personal profile of the user.

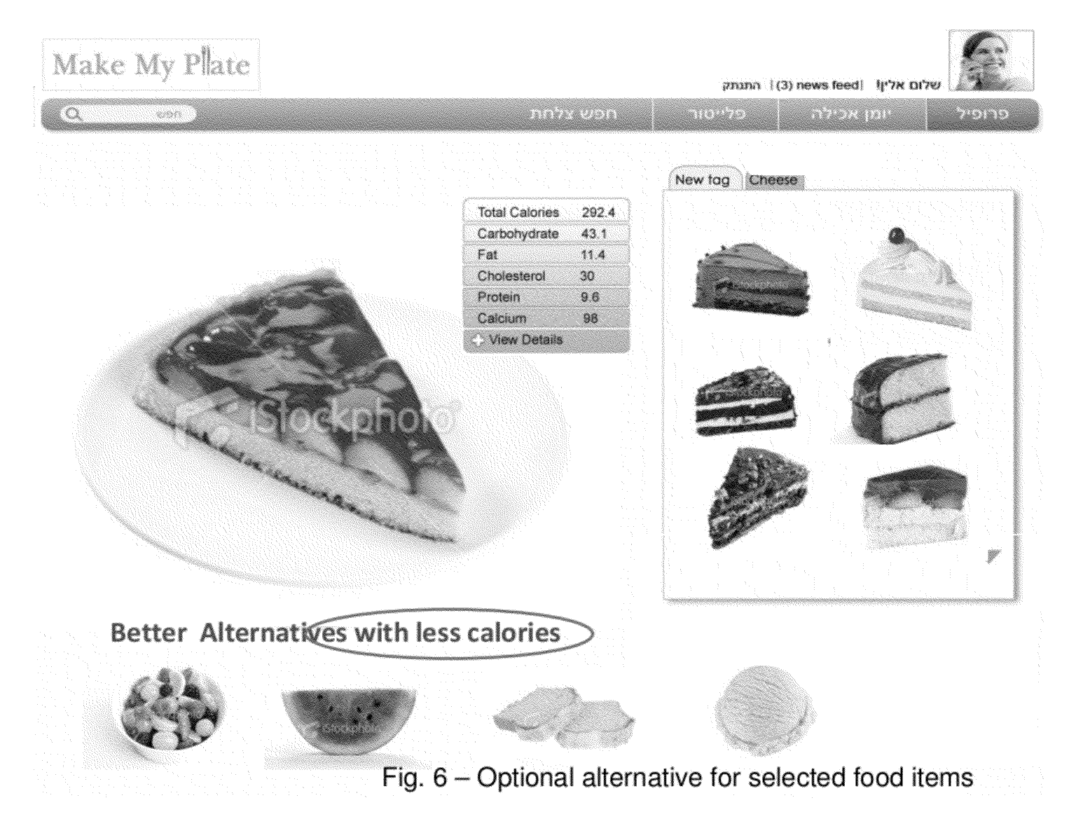

FIG. 6 shows a screen display of a system of the invention demonstrating a plate with selected food indicating nutritional values of selected foods and optional alternatives adjusted for a selected alternative (here less calories food options of selected foods).

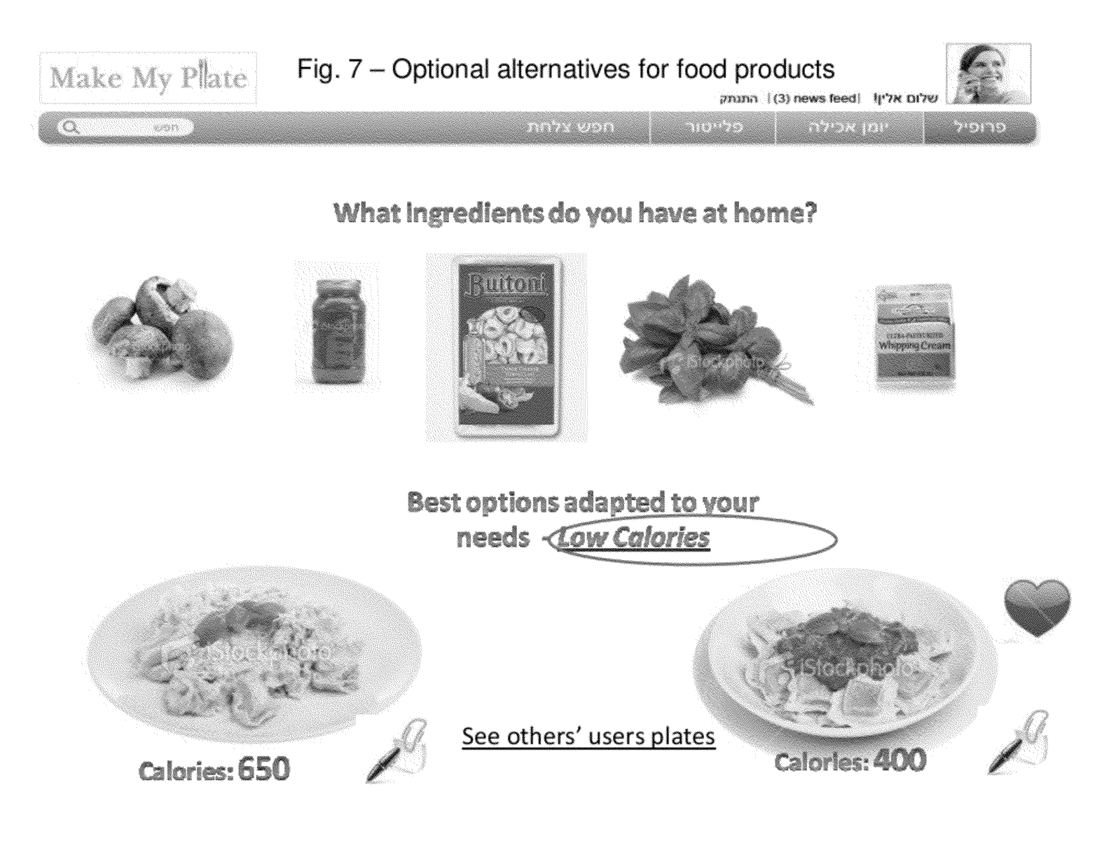

FIG. 7 shows a screen display of a system of the invention demonstrating selected food ingredients for preparing a recipe indicating options adapted for individual predetermined needs.

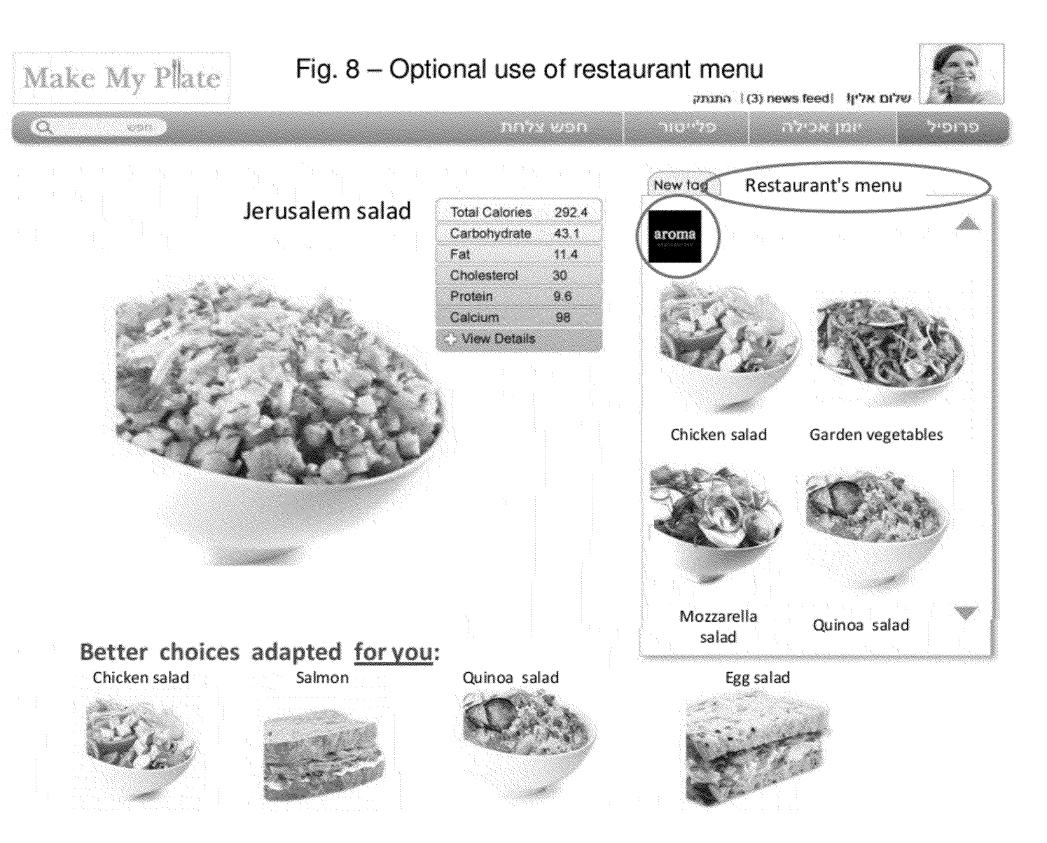

FIG. 8 shows a screen display of a system of the invention demonstrating restaurant's menu options indicating nutritional values of selected foods.

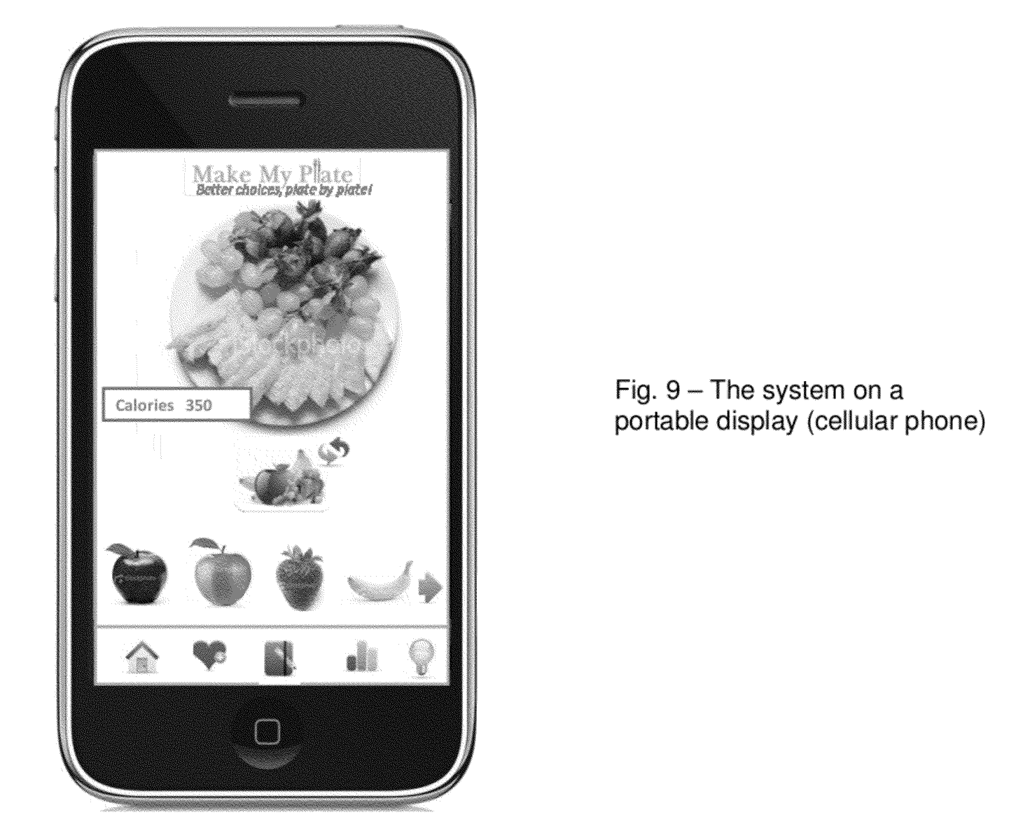

FIG. 9 shows a screen display of a system of the invention implemented on a portable device.

1. A computerized method comprising:
displaying on a computer screen one or more food holding utensils resembling a utensil used by an individual in real life;
providing means for inputting information on food items consumed by individual; and
displaying an image resembling such food items on said utensil;
thereby monitoring the food consumption of an individual.

2. A method according to claim 1, wherein said utensil is a plate, bowl, box, cup, glass or hand-full.

3. A method according to claim 1, wherein said input means are provided within the form of a visualized catalogue of food items.

4. A method according to claim 1, wherein said input means are provided within the form of a visualized catalogue of food items, wherein said visualized catalogue provides the nutritional value of food items.

5. A method according to claim 1, wherein said input means are provided within the form of a visualized catalogue of food items, wherein said visualized catalogue includes virtual representation of food items resembling food items consumed by the individual in real life.

6. A method according to any one of claims 1, wherein said displaying of an image resembling such food items on said utensil includes nutritional data of said food items.

7. A method according to claim 1, wherein said information inputted on food items over a time period consumed by the individual is accumulated.

8. A method according to claim 1, comprising defining a time period and displaying information on food items consumed over said time period.

9. A method according to claim 1, operable over a computer network.

10. A method according to claim 1, operable in a server-client system, said server comprising a data storage and a software for executing the method.

11. A method according to claim 1, operable over a computer network wherein the computer network is the internet.

12. Client server system comprising a plurality of clients and one or more serves, the clients and the one or more servers being connected through a computer network, the server containing an executable software and a database for execution of the method of claim 1.

13. A data storage device storing a computer executable software for execution of the method of claim 1.
